(19) United States
(12) Patent Application Publication
(10) Pub. No.: US 2017/0206993 A1
(43) Pub. Date: Jul. 20, 2017

(54) METHOD OF HYBRID LONG OPERATION TIME POWER SOURCE FOR WIRELESS SENSOR NODES

(71) Applicant: HONEYWELL INTERNATIONAL INC., Morris Plains, NJ (US)

(72) Inventor: Steven TIN, Plymouth, MN (US)

(73) Assignee: HONEYWELL INTERNATIONAL INC., Morris Plains, NJ (US)

(21) Appl. No.: 14/996,642

(22) Filed: Jan. 15, 2016

(51) Int. Cl. G21H 1/06; H01M 8/1018

(52) U.S. Cl. CPC G21H 1/06; H01M 8/1018; H01M 2008/1095; H01M 2250/30; H01M 2300/0082

(57) ABSTRACT

An integrated power source includes a chemical power unit having a fuel cell and a radioactive power unit having betavoltaics. The chemical power unit and the radioactive power unit are integrated with one another to use a common fuel source.

### BACKGROUND OF THE INVENTION

The present invention generally relates to sensors and, more particularly, to apparatus and methods of powering sensors.

State-of-the-art military sensors, such as unattended ground sensors (UGS), constantly consume power to monitor the environment for signal detection although signal of interest often present in less than 0.1% of time. The majority of the energy (>99%) from the onboard chemical battery is wasted sensing and processing irrelevant data, which limits sensors' useful lifetimes to a few weeks or months even operating from state-of-the-art batteries. The need to redeploy power-depleted sensors is not only costly and time-consuming but also increases warfighter exposure to danger.

The same problem also exists with commercial wireless sensors for sensing and tracking. Long life time power source will be needed to power wireless sensors to enable the internet of things.

Chemical batteries have low energy density, but can provide high power output needed for infrequent wireless sensor transmission. Radioisotope-powered batteries have high energy density and long lifetime, but have low power output, which only suitable for persistent signal detection.

As can be seen, there is a need for improved apparatus and methods to power sensors.

### SUMMARY OF THE INVENTION

In one aspect of the present invention, a power source comprises a chemical power unit having a fuel cell; and a radioactive power unit having betavoltaic components; wherein the chemical power unit and the radioactive power unit are integrated with one another for both units to receive fuel from a common fuel source.

In another aspect of the present invention, a power source comprises a chemical power unit having a fuel cell; and a radioactive power unit having: a substrate with a plurality of chambers; a p-n junction at all of the chambers; a fuel source in at least one of the chambers; wherein the fuel source includes a radioisotope; wherein the fuel source directly interfaces the fuel cell.

In yet another aspect of the present invention, a sensor system comprises an unattended sensor; and a power source in communication with the sensor, the power source including: a chemical power unit; and a radioactive power unit; wherein the chemical power unit and the radioactive power unit are integrated with one another to provide both units with fuel from a common fuel source.

These and other features, aspects and advantages of the present invention will become better understood with reference to the following drawings, description and claims.

### BRIEF DESCRIPTION OF THE DRAWINGS

FIG. 1A is a schematic view of a sensor system according to an embodiment of the present invention;

FIG. 1B is a partial, exploded perspective view of a power source in a sensor system according to an embodiment of the present invention

FIG. 2 is an overall, exploded, perspective view of a power source in a sensor system according to an embodiment of the present invention;

FIG. 3A is a perspective view of a doped substrate of the power source of FIG. 2;

FIGS. 3B-1 and 3B-2 are perspective views of both sides of a metalized substrate of the power source of FIG. 2.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Generally, the present invention provides a sensor system with a hybrid battery as a power source. The power source combines high power output of a chemical power source/unit and long lifetime of radioactive power source/unit. The invention can provide a tritium hydride powered fuel cell with integrated betavoltaics. Radioisotope enabled power output can power continuous, low power sensing/detection, signal processing, etc. Chemical enabled power output can power periodic high power signal transmission. This integrated power source can provide long operation time wireless sensor nodes, such as unattended ground sensors, where operation duty cycle is often <0.1%.

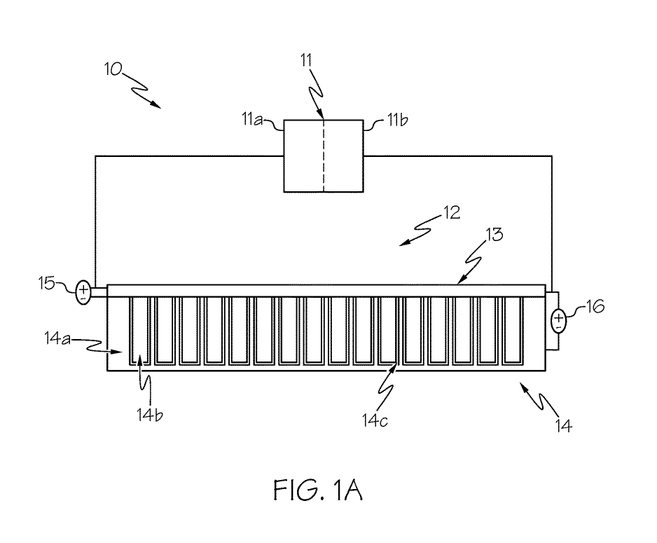

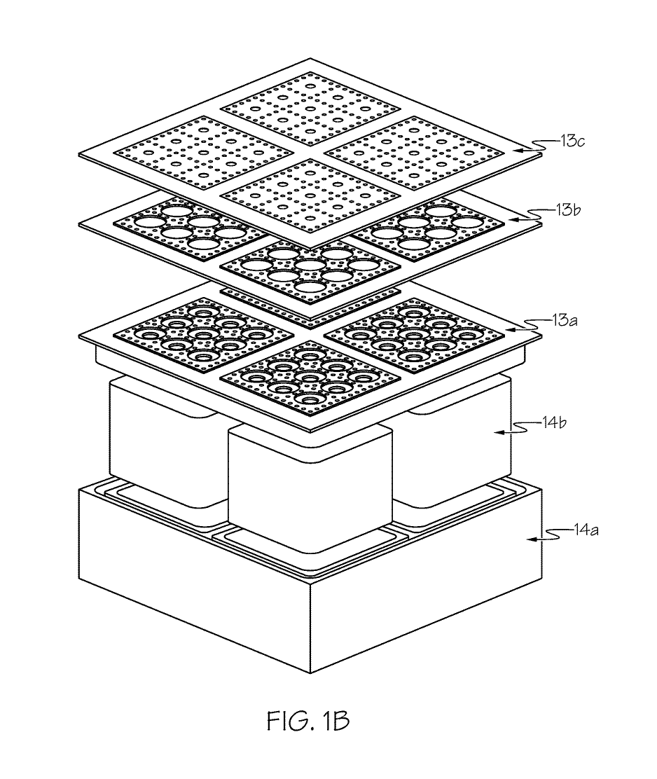

FIG. 1A is a schematic diagram of a system 10 according to an embodiment of the present invention. In embodiments, the system 10 may be a sensor system. In embodiments, the system 10 may include a component 11 which requires power to operate. In embodiments, the component 11 may be an unattended component wherein the component is not monitored by a user. In other embodiments, the component 11 may be an attended sensor or unattended sensor, such as an unattended ground sensor for military applications.

The system 10 may further include a power source 12 which may have a first or chemical power unit 13 and a second or radioactive power unit 14. The first and second power units 13, 14 can be integrated with one another. “Integrated” in the present invention means that the first and second power units share a common fuel source. Also, “integrated” means, in the present invention, that the first and second power units directly interface and are in direct contact with one another. In other words, as an example, the integrated first and second power units are not separately housed from one another. In embodiments, the chemical power unit 13 is sealed to the radioactive power unit 14 at their common interface, such as by non-conductive adhesives.

In FIG. 1B, the first or chemical power unit 13 may provide low energy density, such as an amount of about 10 MJ/kg. In embodiments, the power unit 13 may be a fuel cell, such as a proton exchange membrane fuel cell (PEM fuel cell). As is known in the art, the PEM fuel cell may include an anode 13a, a cathode 13c, and an electrolyte membrane 13b therebetween. In embodiments, the chemical power unit 13 may directly interface to and/or seal with the radioactive power unit 14. In particular, the anode 13a may directly interface with and/or seal to a common fuel source 14b in the power unit 14, as further described below. Thereby, the power unit 14 may receive its fuel from the common fuel source 14b, while air to the fuel cell is provided by the environment and/or an onboard air oxidizer.

Referring back to FIG. 1A, the chemical power unit 13 may generate a power output 15 to power, as an example, the component 11, or a portion thereof. In embodiments, the power output 15 may provide high power output, such as about 10 seconds of milliwatts power. That high power output can be used to operate a portion of the component 11 when, for example, component 11 is an unattended sensor and high power is needed for a transmitting module 11a of the sensor to transmit data, such as to a base station.

The second or radioactive power unit 14 may provide high energy density, such as more than 1000× of chemical power. In the embodiment of FIG. 1A, the power unit 14 may include a plurality of betavoltaic components. In embodiments, the betavoltaic components can include a substrate 14a. In embodiments, the substrate 14a can be made of semiconductor materials, such as Si, SiC or polymer. The betavoltaic components may further include a common fuel source 14b, such as a radioisotope fuel source. In embodiments, the radioisotope fuel source may be tritium hydride. One or more p-n junctions 14c may be included in the betavoltaic components.

In FIG. 1A, the radioactive power unit 14 may generate a power output 16 to power, as an example, the component 11, or a part thereof. In embodiments, the power output 16 may provide low power output, such as about nanoWatts to microWatts level. That low power output can be used to operate a portion of the component 11 when, for example, component 11 is an unattended sensor and low power is needed for a detection module 11b of the sensor to continuously detect objects in the surrounding environment.

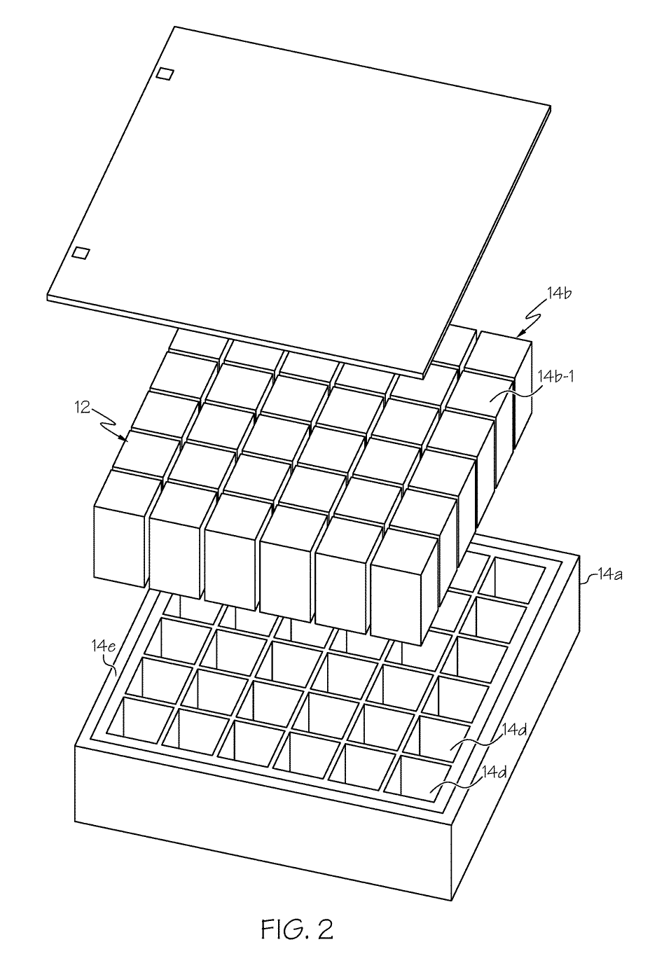

FIG. 2 is an exploded, perspective view of the power source 12 according to an embodiment. The chemical power unit 13 is shown to directly interface the fuel source 14b. In the embodiment shown, the fuel source 14b includes a plurality of fuel source elements 14b-1. Two or more of the fuel source elements 14b-1 can have the same overall configuration and size. Two or more of the fuel source elements 14b-1 can be made of the same fuel material, such as tritium hydride.

The substrate 14a can include, in embodiments, a plurality of chambers 14d. The chambers 14d can be arranged in an array of chambers. One or more chambers can be open at a first side 14e of the substrate 14a Two or more chambers 14d can have the same configuration and size. Further, one or more chambers 14d can be configured and sized to receive one or more fuel source elements 14b-1. In embodiments, one or more of the chambers 14d can be made by etching.

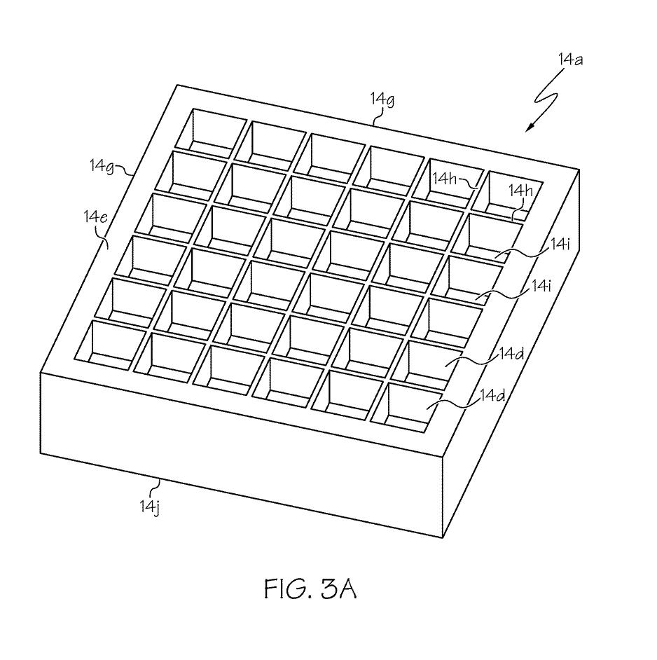

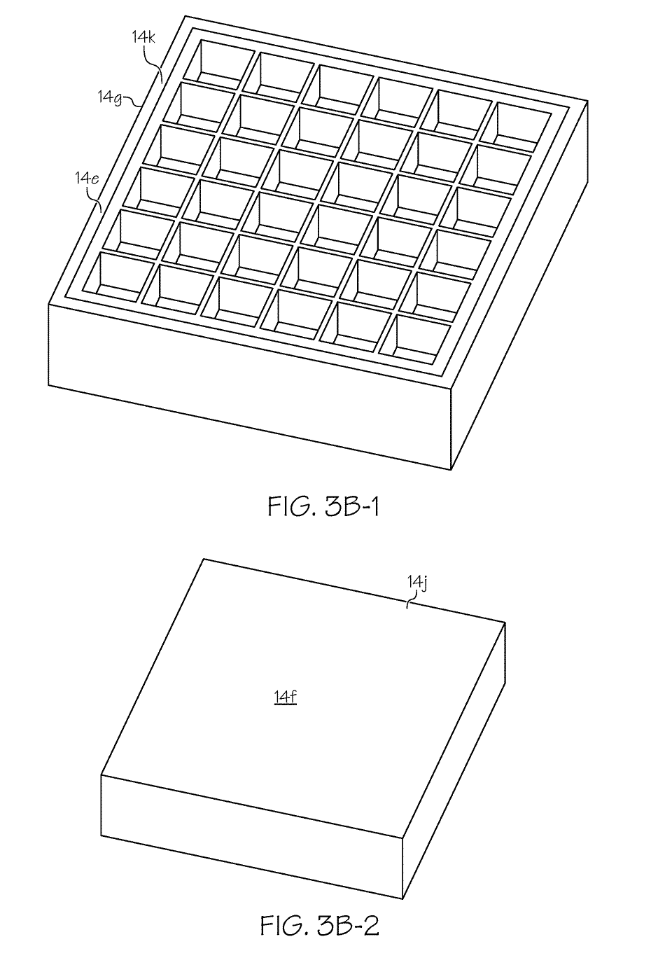

FIG. 3A is a perspective view of the substrate 14a where, in this embodiment, the array of chambers 14d can extend over substantially the entire substrate 14a, but not to peripheral edges 14g of the substrate 14a. In this embodiment, the array is depicted as square in configuration. However, the present invention contemplates that the array can have other configurations and/or extend to the peripheral edges 14g of the substrate 14a. In embodiments, one or more chambers 14d can have one or more walls 14h and a floor 14i. One or more floors 14i can be positioned at a second side 14j of the substrate, wherein the second side 14j is opposite the first side 14e of the substrate.

The substrate 14a may be doped, with one or more dopants, in one or more portions of the substrate 14a. For example, the doping may be on the peripheral edge(s) 14g, the wall(s) 14h, and/or the floor(s) 14i. In an embodiment, the entire substrate 14a can be doped with a first dopant, except for the edges 14g, the walls 14h, and/or the floors 14i. A second dopant can be in the edges 14g, the walls 14h, and/or the floors 14i. In embodiments, the first dopant can be an n-dopant such as phosphorus, and the second dopant can be a p-dopant such as boron.

Accordingly, it can be appreciated that one or more p-n junctions 14c exist in the substrate 14a. In embodiments, one or more p-n junctions 14c exist at one or more chambers 14d. In particular embodiments, one or more p-n junctions exist at one or more walls 14h and/or floors 14i.

FIG. 3B-1 shows the first side 14e of the substrate 14a. A metallic layer 14k extends along at least a portion of the peripheral edges 14g. In embodiments, the metallic layer 14k extends along all of the peripheral edges 14g.

FIG. 3B-2 shows the second side 14j of the substrate 14a. A metallic layer 14f extends over at least a portion of the second side 14j. In embodiments, the metallic layer 14f extends over the entire second side 14j. The metallic layer 14f, in combination with the metallic layer 14k, enables electrical power to be captured and sent to the component 11.

It should be understood, of course, that the foregoing relates to exemplary embodiments of the invention and that modifications may be made without departing from the spirit and scope of the invention as set forth in the following claims.

We claim:

1. A power source, comprising:
a chemical power unit having a fuel cell; and
a radioactive power unit having betavoltaic components;
wherein the chemical power unit and the radioactive power unit are integrated with one another for both units to receive fuel from a common fuel source.

2. The power source of claim 1, wherein the fuel cell is a PEM fuel cell.

3. The power source of claim 1, wherein the chemical power unit directly interfaces the radioactive power unit.

4. The power source of claim 1, wherein the chemical power unit directly contacts the radioactive power unit.

5. The power source of claim 1, wherein the chemical power unit directly contacts the common fuel source.

6. The power source of claim 1, wherein an anode of the chemical power unit directly contacts the radioactive power unit.

7. A power source, comprising:
a chemical power unit having a fuel cell; and
a radioactive power unit having:
a substrate with a plurality of chambers;
a p-n junction at one of the chambers;
a fuel source in the one of the chambers;
wherein the fuel source includes a radioisotope;
wherein the fuel source directly interfaces the fuel cell.

8. The power source of claim 7, wherein the substrate is made of a semiconductor material.

9. The power source of claim 7, wherein two or more of the chambers have the same size and configuration.

10. The power source of claim 7, wherein the chambers are positioned in an array.

11. The power source of claim 7, wherein the fuel source is sealed to the chemical power unit.

12. The power source of claim 7, wherein the fuel source directly contacts the fuel cell.

13. The power source of claim 7, wherein the fuel source includes a plurality of fuel source elements.

14. The power source of claim 7, wherein the p-n junction is at one of a wall and a floor of the chamber.

15. A system, comprising:
an unattended component; and
a power source in communication with the component, the power source including:
a chemical power unit; and
a radioactive power unit;
wherein the chemical power unit and the radioactive power unit are integrated with one another to provide both units with fuel from a common fuel source.

16. The system of claim 15, wherein the chemical power unit includes a PEM fuel cell.

17. The system of claim 15, wherein the radioactive power unit includes betavoltaic components.

18. The system of claim 15, wherein the chemical power unit is sealed to the radioactive power unit.

19. The system of claim 15, wherein the common fuel source is located in the radioactive power unit.

20. The system of claim 15, wherein the common fuel source is tritium hydride.
